(19) United States
(12) Patent Application Publication
(10) Pub. No.: US 2016/0171721 A1
(43) Pub. Date: Jun. 16, 2016

(54) Display Device with Transparent Coating and Method for Making the Same

(71) Applicants: Marc Trachtenberg, New York, NY (US); Ryan Kirch, Northvale, NJ (US); John Shaw, Bayonne, NJ (US)

(72) Inventors: Marc Trachtenberg, New York, NY (US); Ryan Kirch, Northvale, NJ (US); John Shaw, Bayonne, NJ (US)

(21) Appl. No.: 14/968,555

(22) Filed: Dec. 14, 2015

Related U.S. Application Data
(60) Provisional application No. 62/091,366, filed on Dec. 12, 2014.

(51) Int. Cl. G06T 11/00

(52) U.S. Cl. CPC G06T 11/001

(57) ABSTRACT

A display device comprising a display screen for electronically displaying an image, said display screen having a textured surface on which a user can write without altering the image is disclosed. A method for creating a display device having a display screen for electronically displaying an image comprising the step of applying a film directly onto said display screen or applying a chemical or mechanical treatment directly onto said display screen to form a textured surface is also disclosed.

### RELATED APPLICATIONS

This application claims priority to U.S. Provisional Patent Application No. 62/091,366, filed Dec. 12, 2014, the disclosures and teachings of which are incorporated herein by reference.

### FIELD OF THE INVENTION

The present invention relates generally to a video display device with a transparent coating on the screen that creates the look and feel of a painting or a creates a writable surface, and a method for making such a device.

### BACKGROUND

Visual art used to decorate the walls of homes and public places comes in many styles, surfaces, and sizes. Traditionally, wall art is created by painting, drawing, placing, and/or printing colors, shapes, and/or designs such as a photograph or lithograph on a surface, such as canvas, wood, metal, chalkboard and/or paper. Current technologies allow users to display wall art digitally on electronic display devices as well. Display devices have a number of advantages over the traditional surfaces, including the ability to instantly change the image displayed with little to no effort and to display a moving or interactive image. However, images on display devices can be obstructed by glare or reflections on the display screen of the device. Display devices also lack the soft, time-honored look of traditional media. Further, an image on a display device cannot be mixed with other media to create or mimic a more traditional look. The present invention includes using a film for electronic display surfaces that creates a soft, painting-like, photograph-like, or lithograph-like look to an image displayed on an electronic device. The film may also allow a user to write directly on the surface of the display to give the user the ability to mix electronic art with traditional materials such as chalk or dry-erase markers.

### BRIEF SUMMARY

In general in one aspect, exemplary embodiments of the present invention may provide a display device comprising a display screen for electronically displaying an image, said display screen having a textured surface on which a user can write without altering the image. Implementations of the various exemplary embodiment of the present invention may include one or more of the following features: The user can write on said surface using chalk. The user can write on said surface using a dry erase marker. The textured surface alters optical properties of the said image. The said textured surface is formed by a mechanical treatment of said display screen. The textured surface is formed by a chemical treatment of said display screen. The textured surface is formed by placing a removable film on said display screen. The said textured surface is transparent.

In general in one aspect, exemplary embodiments of the present invention may provide a display device comprising a display screen for electronically displaying an image, said display screen having a textured surface for altering the image to create a look and feel of a non-electronic work of art. Implementations of the various exemplary embodiment of the present invention may include one or more of the following features: The textured surface alters optical properties of said image. The textured surface is formed by a mechanical treatment of said display screen. The textured surface is formed by a chemical treatment of said display screen. The textured surface is formed by placing a removable film on said display screen. The said textured surface is transparent.

In general in one aspect, exemplary embodiments of the present invention may provide a method for creating a display device having a display screen for electronically displaying an image comprising the step of applying a chemical or mechanical treatment directly onto said display screen to form a textured surface. Implementations of the various exemplary embodiment of the present invention may include one or more of the following features: The step of applying a protective coating on said display screen. The chemical or mechanical treatment involves applying a texturizing product.

In general in one aspect, exemplary embodiments of the present invention may provide a method for creating a display device having a display screen for electronically displaying an image comprising the step of applying a film directly onto said display screen to form a textured surface. Implementations of the various exemplary embodiment of the present invention may include one or more of the following features: The step of applying a protective coating on said display screen. The film is permanently affixed to said display screen.

### BRIEF DESCRIPTION OF THE DRAWINGS

FIG. 1 depicts an example of the present invention showing a front view of a display device displaying a digital image with a textured surface;

FIG. 2 depicts the same example of the present invention shown in FIG. 1, also showing chalk writing on the textured surface;

FIG. 3 is a front view of a display device with the textured surface and displaying a digital image of a cup of coffee with chalk writing on the textured surface overlaying the image of the cup of coffee;

FIG. 4 is a front view of a display device with the textured surface displaying a digital image of a cup of coffee in which the chalk writing overlaying the image has been erased; and

FIG. 5 is a top partial perspective view of a display device having the textured surface with a stippled outer surface and surrounded by a frame shown in dotted lines.

### DETAILED DESCRIPTION OF PREFERRED EMBODIMENTS OF THE INVENTION

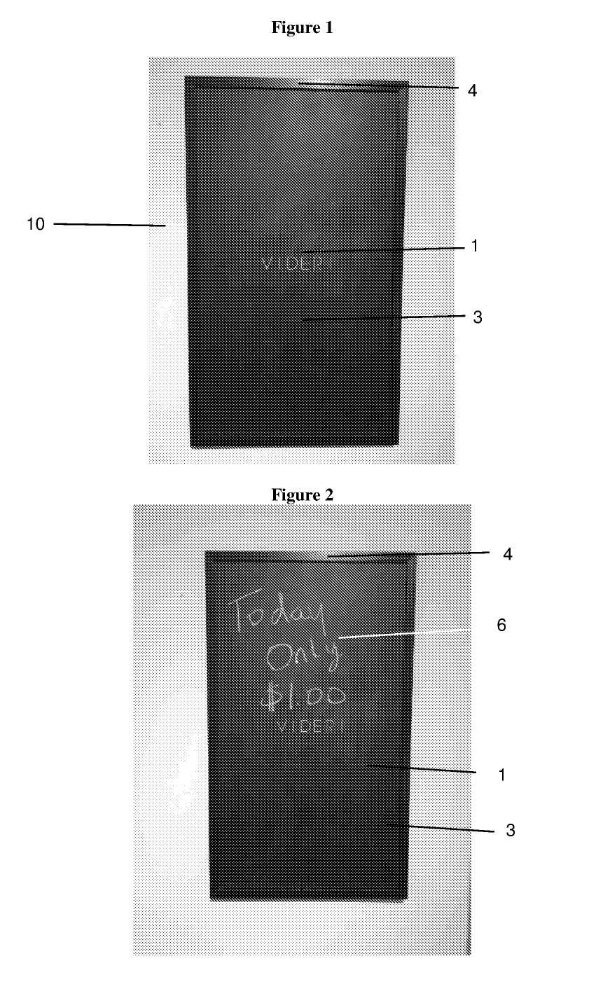

Description will now be given of the invention with reference to the attached FIGS. 1-5. Other and further features and advantages of the present invention will be apparent from the following descriptions of the various embodiments when read in conjunction with the accompanying drawings. It will be understood by one of ordinary skill in the art that the following embodiments are provided for illustrative and exemplary purposes only and that numerous combinations of the elements of the various embodiments of the present invention are possible. Preferred embodiments of the present invention are illustrated by way of example, and not by way of limitation, in the accompanying drawings and in which like reference numerals refer to similar elements.

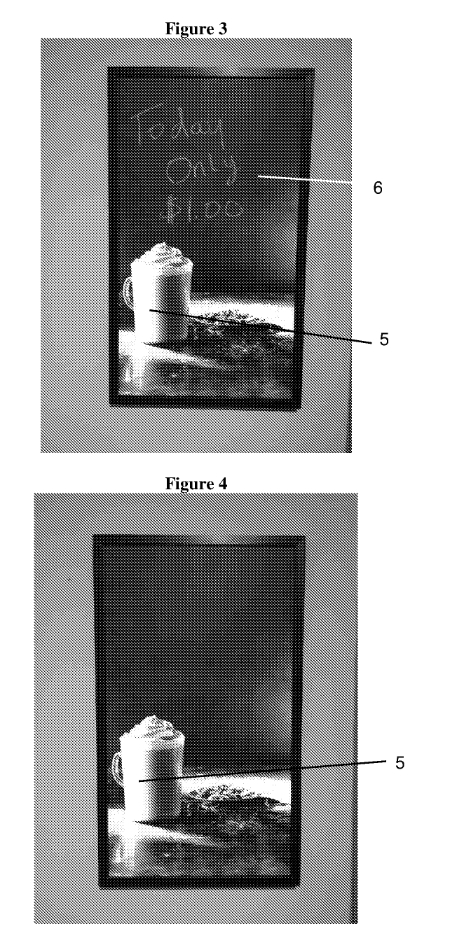

The invention includes a video display device 10 with a display screen 3 that has a transparent textured surface 1 as seen in FIG. 1. This video display device is capable of displaying images and art work in a manner similar to that of traditional wall art, allowing the user to enjoy digital art with the soft look and feel of non-electronic images. The video display 10 may be any electronic device capable of displaying an image including, for example, a television, computer monitor, tablet, or phone. In one embodiment of the invention, the texture alters the surface of the device to give the image displayed 5 the look and feel of a painting, drawing, or other type of wall art. In other embodiments it may otherwise alter optical properties of the displayed image, such as to filter out specific wavelengths of light or to polarize the emitted light forming the image. In yet another embodiment of the invention, the textured surface enables a user to write directly on the screen and to mix digital art with traditional media, as shown in FIGS. 2 and 3.

The type and degree of the texture can vary, with different devices having different textures or gradients of the texture on one screen. The texture can be smooth and glass-like, or it may be rough. The texture can be transparent or semi-transparent in such a way that the image appears slightly distorted. A transparent surface might be preferred in a situation where a user would like to superimpose an image or message 6 above the digital image 5 and would like the underlying digital image 5 to be clearly visible. A semi-transparent texture might be preferred in embodiments of the invention intended to mimic a painting, in which colors often blend together. In those embodiments, the semi-transparent coating will create a distortion to blur the image beneficially and to create the illusion that the colors are mixing and blending.

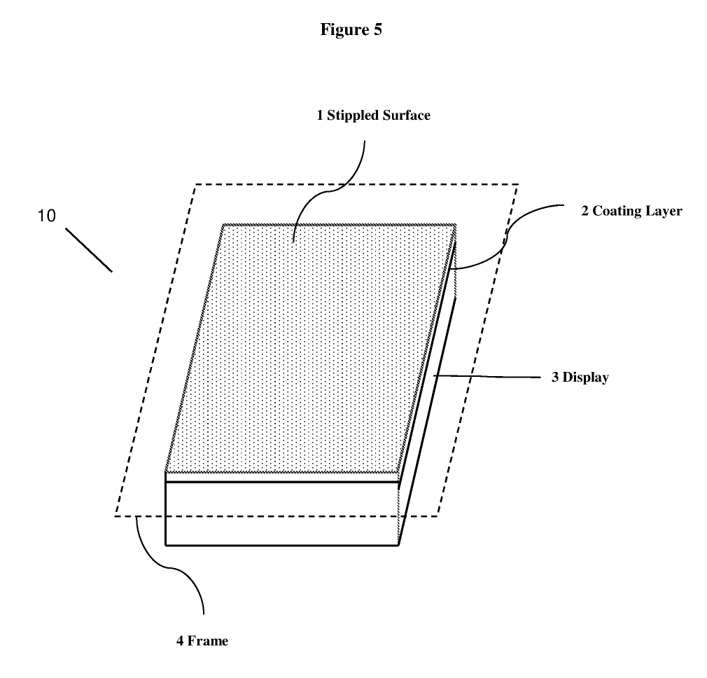

The surface 1 may be manufactured with the display screen 3 so that it is permanently attached. Alternatively, the surface can be a removable layer applied to the screen of the device during manufacture or after manufacture by a user. In yet another alternative, the surface of a purchased device 10 can be altered permanently by a user. The surface is at least partially transparent so that any image displayed on the video display device 10 shows through and is enhanced by the surface 1 as demonstrated in FIG. 3. In preferred embodiments, the surface 1 is stippled to give the displayed image the look of a painting or other work of art as in FIG. 5. This feature allows a user to use the device to display artwork and posters on the screen in a realistic and artistic way. The screen 3 might further include artistic framing 4, made of wood or another material, to make the device 10 more closely resemble a painting. The frame 4 may be attached to the display itself or it may be removable, such as a common picture frame or professional custom framing. The device 10 can alternatively be dropped into a frame hung on a wall using a traditional steel wire and hook mechanism. In other embodiments, the surface 3 creates a writable overlay so that a user can use the surface 3 as, for example, a chalkboard as seen in FIGS. 2 and 3. Other types of boards are possible as well with the current invention, such as a dry erase board. In this embodiment, the user is able to write or draw directly on the surface 3 of the display on top of the displayed image 5 to either supplement or cover the displayed image 5 as it is viewable under the transparent surface as in FIG. 3. The image may be static or moving. Alternatively, a user can choose to display a solid color on the device 10 and simply use the device as an ordinary chalkboard as in FIG. 2. Further a user can choose not to write on the surface 3 at all, or erase an existing writing 6 on the surface, and use the device 10 as an ordinary display as in FIG. 4. In even further embodiments, the video display device 10 is also able to interact with the user's writing 6 on the surface.

For example, the attached figures demonstrate a typical use of the invention. FIG. 1 shows the device 10 with a primarily solid background and no writing. The screen has a matte feel. In FIG. 2 a user has written on the screen 3 with chalk the phrase, “Today Only $1.00.” The device 10 is used there as an ordinary chalkboard. FIG. 3 shows the same device with an image 5 of a coffee cup displayed on the video display device 10. The same writing 6 remains, but now with an image 5 behind the wording. It will be appreciated by a person of ordinary skill in the art that the image 5 behind the writing may be changed as well while the writing 6 remains unaffected and visible. In FIG. 4, the chalk writing 6 has been erased to show only the displayed image 5 and demonstrate that the display device can be used independently from the user's writing.

Additionally, the product can be packaged and sold as a kit for creating such a surface on an existing video display 10. The kit can create a permanent new coating on the screen or can provide a removable coating that can be detached when desired. In embodiments where the coating is permanent, the kit can include a film that covers the display screen or a bottle of a material that a user will apply to create the textured surface 3. Alternatively, the kit can offer instruction only using off the shelf third party products, such as Decoart's Clear Chalkboard Coat, available on the company's website at http://decoart.com/cgibin/Products.cgi?Clear_Chalkboard_Coating.

The invention additionally includes a method or methods for creating the above product. One method includes using a texturizing or chalkboard product, such as Decoart's Clear Chalkboard Coat, on the screen of a display device 10. Similarly, one might use a mechanical or chemical treatment directly on the display surface to create a permanent stippled surface. Another method includes first applying a protective or sealing coating on the screen of the display device to prevent substances from entering the enclosure of the device and affecting internal components and then applying a texturizing or chalkboard product. The protective coating can be akin to an anti-glare or anti-scratch coating that will protect the screen, or it can be more like a plastic film that allows the newly applied textured coating to be removable from the video display device when desired. The texturizing or chalkboard product may come in a bottle with the product as a liquid or gel which is applied to the screen. In embodiments of the invention with a removable textured surface, the surface may be achieved by attaching a film with a static process or a reversible adhesive substance. A protective film may or may not also be applied.

What is claimed is:

1. A display device comprising a display screen for electronically displaying an image, said display screen having a textured surface on which a user can write without altering the image.

2. A display device as claimed in claim 1 wherein the user can write on said surface using chalk.

3. A display device as claimed in claim 1 wherein the user can write on said surface using a dry erase marker.

4. A display device as claimed in claim 1 wherein said textured surface alters optical properties of the said image.

5. A display device as claimed in claim 1 wherein said textured surface is formed by a mechanical treatment of said display screen.

6. A display device as claimed in claim 1 wherein said textured surface is formed by a chemical treatment of said display screen.

7. A display device as claimed in claim 1 wherein said textured surface is formed by placing a removable film on said display screen.

8. A display device as claimed in claim 1 wherein said textured surface is transparent.

9. A display device comprising a display screen for electronically displaying an image, said display screen having a textured surface for altering the image to create a look and feel of a non-electronic work of art.

10. A display device as claimed in claim 9 wherein said textured surface alters optical properties of said image.

11. A display device as claimed in claim 9 wherein said textured surface is formed by a mechanical treatment of said display screen.

12. A display device as claimed in claim 9 wherein said textured surface is formed by a chemical treatment of said display screen.

13. A display device as claimed in claim 9 wherein said textured surface is formed by placing a removable film on said display screen.

14. A display device as claimed in claim 9 wherein said textured surface is transparent.

15. A method for creating a display device having a display screen for electronically displaying an image comprising the step of applying a chemical or mechanical treatment directly onto said display screen to form a textured surface.

16. A method as claimed in claim 15 further comprising the step of applying a protective coating on said display screen.

17. A method as claimed in claim 15 wherein said chemical or mechanical treatment involves applying a texturizing product.

18. A method for creating a display device having a display screen for electronically displaying an image comprising the step of applying a film directly onto said display screen to form a textured surface.

19. A method as claimed in claim 18 further comprising the step of applying a protective coating on said display screen.

20. A method as claimed in claim 18 wherein said film is permanently affixed to said display screen.
